(19) United States
(12) Patent Application Publication
(10) Pub. No.: US 2005/0274593 A1
(43) Pub. Date: Dec. 15, 2005

(54) Push switch

(75) Inventor: Kenji Kawano, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/146,192

(22) Filed: Jun. 6, 2005

(30) Foreign Application Priority Data
Jun. 10, 2004 (JP) 2004-172695

(51) Int. Cl. F16K 51/00; H01H 9/00

(52) U.S. Cl. 200/314

(57) ABSTRACT

A slider is provided with projections. Each projection is formed with tapered surfaces. A casing is provided with concave portions having the same shape as the projections. During the return of an operating body, the slider ascends while being inclined, and the slider stands upright as the tapered surface of the projection and the tapered surface of the concave portion of the casing slide on each other. Then, each projection is fitted into the corresponding concave portion, thereby positioning the slider.

### BACKGROUND OF THE INVENTION

1. Field of the Invention

The present invention relates to a push switch which prevents an impact noise from being generated during the return of a slider after the slider is pressed.

2. Description of the Related Art

A push switch is publicly known in Japanese Unexamined Utility Model Registration Application Publication No. 5-55420 and shown in FIGS. 9 and 10. In the push switch, an operating member is pressed to bring a movable contact into contact with and separated from a fixed contact, and the movable contact and the fixed contact are accommodated in a casing. If the pressing is released by a return member, these contacts return to their initial positions. Section lines in FIGS. 9 and 10 pass through a front leg and a rear leg which will be described later.

In the drawings, reference numeral 20 denotes a push button switch of a hysteresis mechanism. The push button switch 20 is constructed such tat an operating body 22 is mounted on a casing 21, and the operating body 22 is depressed to allow switching operation. The casing 21 of the push button switch 20A is formed with a rectangular bulging portion 23, and the operating body 22 is mounted in the bulging portion 23. That is, sliding portions 24 are suspended from the four corners of the operating body 22, and the sliding portions 24 are formed so as to slide vertically inside the four corners of the casing 21. Therefore, the operating body 22 is mounted to be vertically movable with respect to the casing 21.

A coil spring 25 is fitted into the middle of the rear surface of the operating body 22 and is suspended from the surface. A membrane switch 26 is provided beneath the bottom of the casing 21. A click rubber 27 is provided between the coil spring 25 and the membrane switch 26 such that a head of the click rubber 27 is fitted to a lower portion of the coil spring 25. A pressing portion 28 protruding from the other side of the head of the click rubber 27 is positioned above contacts 29 and 30 of the membrane switch 26.

On the other hand, between a pair of the sliding portions 24 provided back and forth (the front side of the drawing is forth, and the rear side of the drawing is back), a front leg 31 and a rear leg 32 are suspended. Similarly, a front leg 31 and a rear leg 32 are suspended between another pair of sliding portions 24, and lower ends of the front legs 31 project outward to form stoppers 33. Lower ends of the rear legs 32 are provided with projections 34. The projection 34, as shown in FIG. 10, is formed in the shape of a taper which is widened outward from the top toward the bottom. Further, an upper edge 35 of the bulging portion 23 of the casing 23 is stepped. In addition, the stoppers 33 protrude in a direction substantially orthogonal to the legs 31 to be locked to the upper edge 35 of the bulging portion 23.

The projections 34 formed at the rear legs 32, as shown in FIG. 10, are widened from locations slightly above the stoppers 33, and the rear legs 32 are made narrower than the front legs 31. Therefore, the rear legs 32 have a larger elastic force than the front legs 31. That is, the front legs 31 are not bent and the operating body 22 is not separated from the casing 21 unless the operating body 22 is intentionally detached from the casing. On the other hand, the lower edge of the click rubber 27 is provided with an outwardly protruding seat 36. The seat 36 is formed so that the legs 31 can be seated thereon.

When the operating body 22 is pressed, the coil spring 25 urges the click rubber 27 with the decent of the operating body 22, and the pressing portion 28 of the click rubber 27 presses the contact 29 of the membrane switch 26. Accordingly, the contact 29 contacts the contact 30. At this time, the legs 31 are seated on the seat 36 of the click rubber 27, which prevents generation of an impact noise of the legs 31.

When the operating body 22 is released from pressing, the operating body 22 returns to its original uppermost position by an elastic forces of the click rubber 27 and the coil spring 25. At this time, before the stoppers 33 provided at the front legs 31 reach the upper edge 35 of the casing 21, the projections 34 of the rear legs 32 contact the upper edge 35. As the operating body 22 ascends, the legs 32 are bent and pressed against the upper edge 35 of the casing 21.

When the operating body 22 ascends, the stoppers 33 are locked to the upper edge 35 of the casing 21 to stop the ascent of the operating body 22. Accordingly, the pressing of the projections 34 against the upper edge 35 of the casing 21 relieves an impact caused between the stoppers 33 and the casing 21 when the ascent of the operating body 22 stops, which prevents generation of an impact noise.

In such a conventional push switch, before the stoppers 33 of the front legs 31 reach the upper edge 35 of the casing 21, the projections 34 of the rear legs 32 contact the upper edge 35. Also, as the operating body 22 ascends, the legs 32 are bent and pressed against the upper edge 35 of the casing 21. Moreover, when the operating body 22 ascends, the stoppers 33 are locked to the upper edge 35 of the casing 21 to stop the ascent of the operating body 22. Accordingly, the pressing of the projections 34 against the upper edge 35 of the casing 21 relieves the impact caused between the stoppers 33 and the casing 21 when the ascent of the operating body 22 stops, which prevents generation of an impact noise.

However, since the vertical movement of the operating body 22 is guided by the casing 21, the tapered surfaces of the projections 34 of the operating body 22 come into collision with the upper edge 35 of the casing 21, which is not enough to weaken the noise.

Also, the operating body 22 in its non-operative state is positioned by the flat surfaces of the stoppers 33 and the upper edge 35 after the legs 32 are elastically deformed, which requires elasticity to be given to the legs 32. Therefore, the push switch needs to be designed in consideration of the spring pressure of the return members (the click rubber 27 and the coil spring 25), the strength of the legs 32, etc. There are also limitations to the adjustment of the elasticity.

It is an object of the present invention to provide a push switch which prevents generation of an impact noise during the return of an operating body which has been pressed and which has no chattering in a non-operative state.

### SUMMARY OF THE INVENTION

In order to achieve the above-described object, the push switch of the present invention includes an operating body having an operating body regulating portion, a casing having a guide portion for holding the operating body in a vertically movable manner, and a casing regulating portion for regulating movement of the operating body in a direction opposite to a pressed and moved direction of the operating body by abutting the operating body regulating portion, a return member which gives an elastic force so as to make the operating body regulating portion abut on a casing regulating portion, fixed and movable contact which are brought into contact with or separated from each other according to a pressing operation and a releasing operation of the operating body, a first tapered surface provided in at least one of the operating body and the casing and inclined from an operating direction of the operating body and a second tapered surface parallel to the first tapered surface, and a gap provided between the casing and the operating body for allowing the operating body to move. During the return of the operating body, the operating body is abutted against and guided by the first tapered surface and the second tapered surface, and then the operating body regulating portion abuts on the casing regulating portion to regulate the position of the operating body in its operating direction.

By the above construction, since the operating body slides while abutting the first and second tapered surfaces, an impact noise caused by bouncing is weakened. In addition, since the operating body regulating portion abuts on the casing regulating portion to regulate the location of the operating body, the operating body can be easily positioned.

In the above-described push switch of the present invention, an operating portion protrudes from the middle of the operating body, and the first and second tapered surfaces face each other with the operating portion therebetween.

By the above construction, since the tapered surfaces are provided to be separated from each other, the sliding becomes more stable.

In the push switch of the present invention, at least one of the operating body regulating portion and the casing regulating portion is provided continuously with the first and second tapered surfaces.

By the above construction, the structure for preventing the noise from being generated during the return of the operating body and the structure for positioning the operating body can be simplified.

In the push switch of the present invention, the first tapered surface and the operating body regulating portion of the operating body or the casing regulating portion of the casing defines a V-shaped tapered surface. The operating body and the casing abut on parallel tapered surfaces on one side, and then abut on parallel tapered surfaces on the other side.

By the above construction, although the center of the projection is shifted from the center of the concave portion on the V-shaped tapered surfaces to some degree when the projection is fitted into the concave portion, noise can be prevented from being generated during the return of the slider, and the operating body can be surely positioned in plan view.

In the push switch of the present invention, in plan view, a V-shaped tapered surface is defined on a surface orthogonal to the V-shaped tapered surface to form a quadrangular pyramid surface.

By the above construction, although the center of the projection is shifted from the center of the concave portion in any directions on the V-shaped tapered surfaces to some degree when the projection is fitted into the concave portion, noise can be prevented from being generated during the return of the slider, and the operating body can be surely positioned in plan view.

According to the present invention, since the sliding occurs in contact between the first and second tapered surfaces, the noise caused by the bouncing is weakened. Since the operating body regulating portion abuts on the casing regulating portion to regulate the position of the operating body, the operating body can be surely positioned.

### BRIEF DESCRIPTION OF THE DRAWINGS

FIG. 1 is a sectional view showing the state where a push switch related to a first embodiment of the present invention is not pressed;

FIG. 2 is a transverse sectional view showing the push switch shown in FIG. 1;

FIG. 3 is an enlarged sectional view showing main parts of the push switch in FIG. 1;

FIG. 4 is an explanatory view showing the operation state of the push switch shown in FIG. 1;

FIG. 5 is an explanatory view showing the operation state of the push switch shown in FIG. 1;

FIG. 6 is an explanatory view showing the operation which prevents generation of an impact noise;

FIG. 7 is an explanatory view showing the operation of the push switch according to the first embodiment;

FIG. 8 is a sectional view showing main parts of a push switch related to a second embodiment of the present invention;

FIG. 9 is a sectional view of a conventional push switch; and

FIG. 10 is a sectional view showing main portion of the push switch shown in FIG. 9.

### DESCRIPTION OF THE PREFERRED EMBODIMENTS

Hereinafter, push switches according to preferred embodiments of the present invention will now be described with reference to the accompanying drawings.

First Embodiment

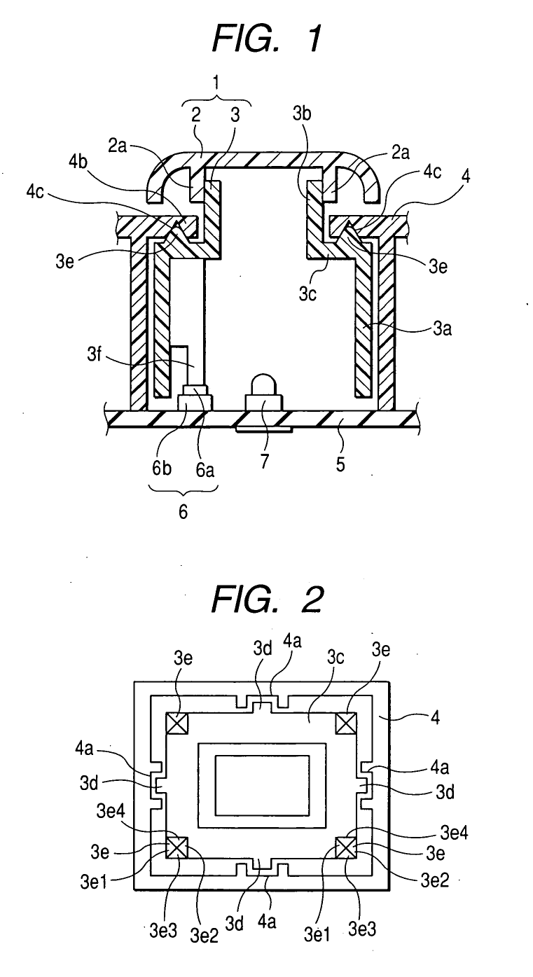

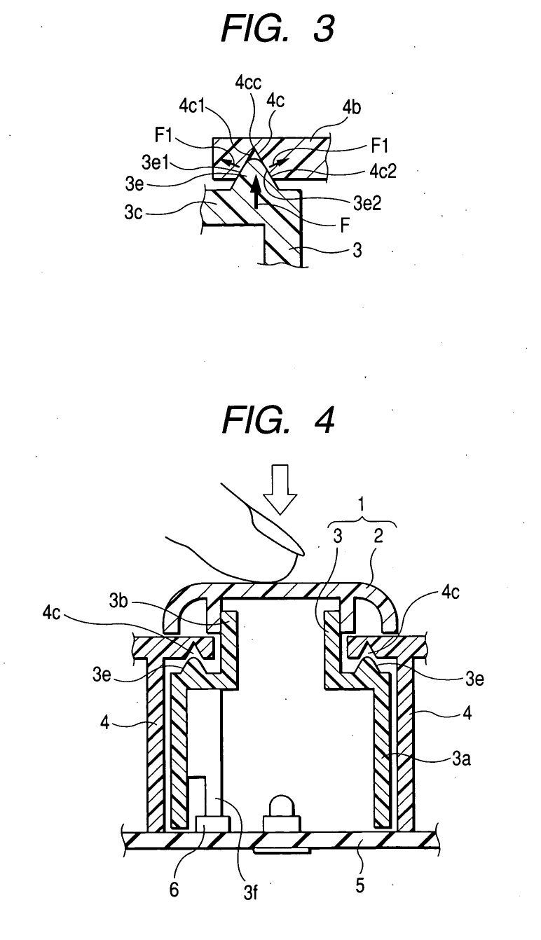

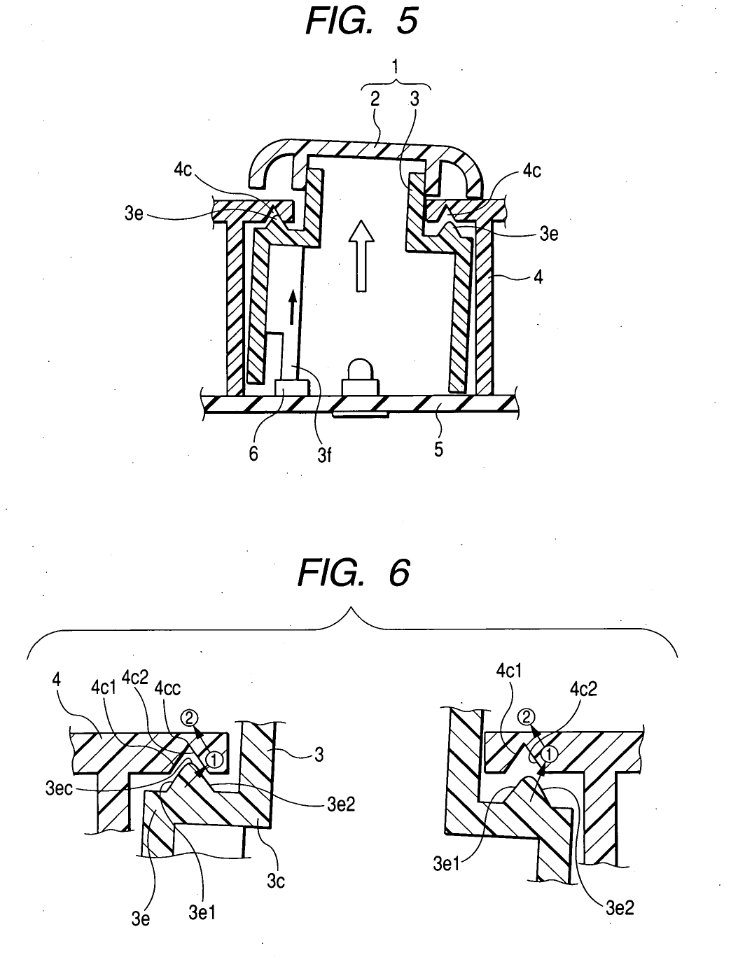

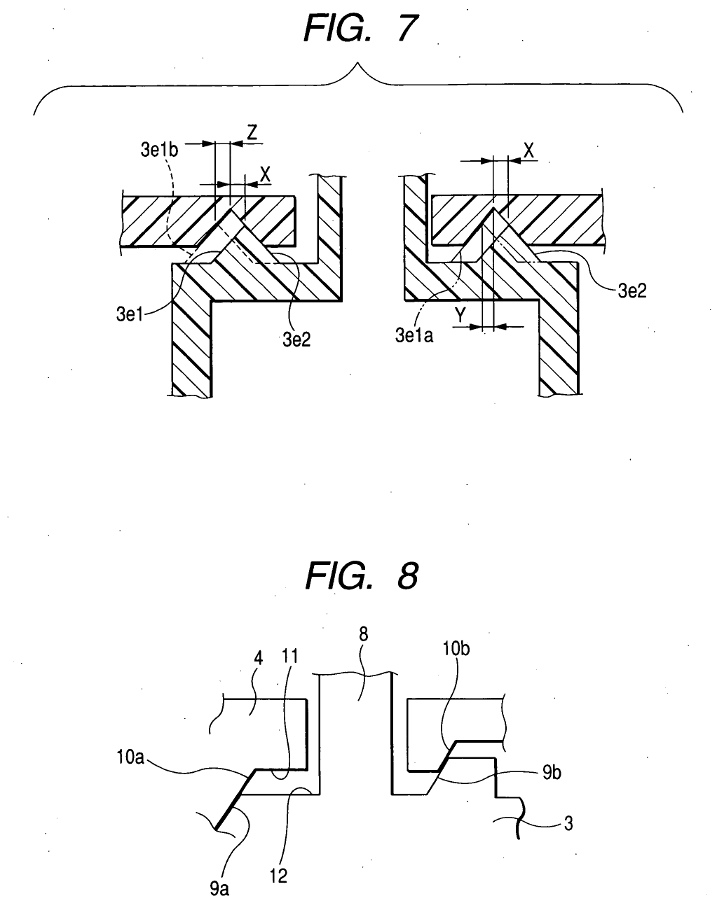

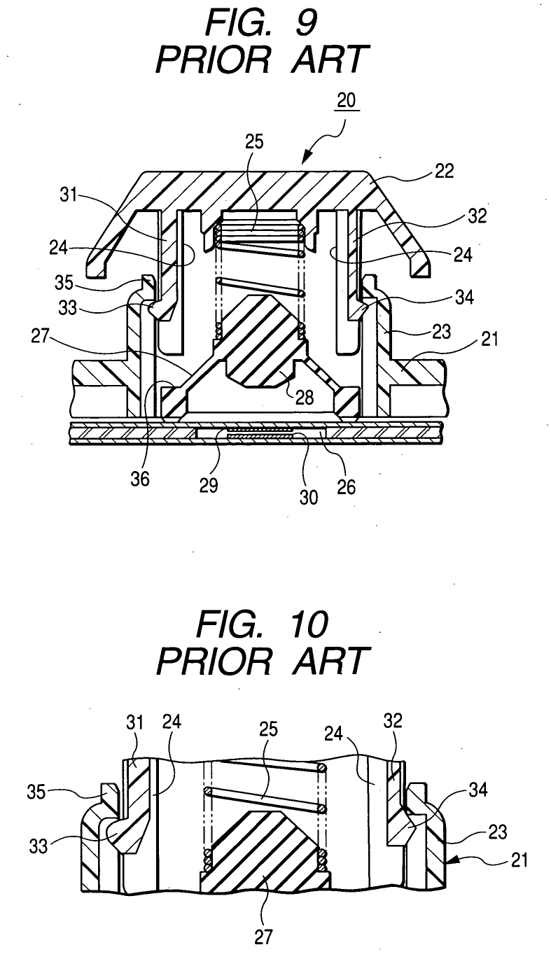

FIG. 1 is a sectional view showing the state where a push switch related to a first embodiment of the present invention is not pressed. FIG. 2 is a transverse sectional view showing the push switch shown in FIG. 1. FIG. 3 is an enlarged sectional view showing main parts of the push switch in FIG. 1. FIG. 4 is an explanatory view showing the operation state of the push switch shown in FIG. 1. FIG. 5 is an explanatory view showing the operation state of the push switch shown in FIG. 1. FIG. 6 is an explanatory view showing the operation which prevents generation of an impact noise. FIG. 7 is an explanatory view showing the operation of the push switch according to the embodiment. In addition, the inclination and clearance of an operating body are indicated larger than an actual size in the drawings.

In the push switch of the present embodiment, as shown in FIGS. 1 to 7, reference numeral 1 denotes the operating body as a whole, the operating body 1 is composed of a knob 2 and a slider 3 which are respectively molded from synthetic resin. The knob 2 is molded in the shape of a box whose bottom surface is opened, and engaging projections 2a are formed on the middle of the lower surface of a top plate. On the other hand, the slider 3 includes a slider body 3a molded in the shape of a rectangular frame whose top and bottom surfaces are opened, a knob attaching portion 3b having a smaller diameter formed at an upper portion of the slider body 3a, and a stepped portion 3c provided between the slider body 3a and the attaching portion 3b. The middle of each of all the side walls of the slider body 3a is provided with a vertically extending projection strip 3d. Quadrangular pyramid-shaped projections 3e are respectively provided at four corners of the stepped portion 3c of the slider 3. Since each projection 3e is quadrangular pyramid-shaped, tapered surfaces 3e1 (operating body regulating portion) and 3e2 having a V-shaped section are formed. Further, in an arrangement in a direction orthogonal the above tapered surfaces in plan view, tapered surfaces 3e3 and 3e4 having a V-shaped section are formed. Moreover, the projections 3e are respectively disposed at four spots around the attaching portion 3b to which the knob 2 is attached, and the tapered surfaces 3e1 of the respective projections 3e are set parallel to each other. Similarly, the tapered surfaces 3e2, 3e3 and 3e4 are respectively set parallel to each other. The vicinity of one side of the interior of the slider body 3a (left side in FIG. 1), is provided with a driving portion 3f formed of a plate piece whose lower end is made narrower than the other portion. The driving portion 3f is adapted to press down a switch portion 6. The knob 2 and the slider 3 are joined to each other and integrated into one body by fitting the attaching portion 3b into the engaging projection 2a.

Reference numeral 4 denotes a casing. The casing 4 is placed on and fixed to a predetermined position of a printed board 5 by proper means, such as welding. Every inner lateral surface of the casing 4 is provided with a guide groove 4a (guide portion) composed of a pair of vertical projection strips. As the projection strip 3d moves along the inside of the guide groove 4a, the slider 3 and the knob 2 integral with the slider 3 are guided to move vertically with respect to the casing 4. Quadrangular pyramid-shaped concave portions 4c are respectively provided at positions corresponding to the projections 3e of the slider 3 on the bottom surface of a top plate 4b having an opening of the casing 4. Thus, in a state of non-operation (FIG. 1), the projections 3e are fitted into the corresponding concave portions 4c and positioned therein. In each concave portion 4c, tapered surfaces 4c1 (casing regulating portion), 4c2, 4c3 and 4c4 are formed to face the above-described tapered surfaces 3e1, 3e2, 3e3 and 3e4 of each of the projections 3e. In the state of FIG. 1, the tapered surface 3e1 of the projection 3e is formed to have substantially the same shape as the tapered surface 4c1 of the concave portion 4c so that the tapered surfaces engage each other.

Incidentally, a clearance exists between the lateral surface of the slider body 3a and the inner lateral surface of the casing 4 so that the slider body 3a can be smoothly pressed.

Reference numeral 6 denotes a switch portion. The switch portion 6 includes, for example, a tact switch and is provided at a position shifted from the center of the knob 2. The switch portion 6 is composed of a tab 6a, an elastic movable contact (not shown but equivalent to a return member) provided beneath the tab 6a and made of a conductive material, two fixed contacts (both not shown) formed at an inner bottom surface and a case 6b. The switch portion 6 has its terminal fixed to a mounting hole or a connecting pattern formed in the printed board 5 by soldering, etc. Also, the tab 6a is pressed or released by the driving portion 3f of the slider body 3a so that the movable contact is brought into contact with and separated from the two fixed contacts.

In addition, reference numeral 7 denotes a lamp for illuminating an illuminating display portion of the knob 2. For convenience of illuminating, the lamp 7 is disposed just below the center of the knob 2 in plan view.

Next, the operation of the push switch will be described with reference to FIGS. 1 to 6. In a non-operative state of the operating body 1 (the slider body 3a), as shown in FIG. 1, the slider body 3a is urged upward in the casing 4 by an elastic force of the movable contact of the switch portion 6. In this case, as shown in FIG. 3, the projection 3e of the slider 3 abuts on the concave portion 4c and is fitted into each of the concave portion 4c of the casing 4. At this time, an elastic force F is divided into partial forces F1 and F1 which act on the V-shaped tapered surfaces 4c1 and 4c2 from the projection 3e (the partial force F is also applied to the other tapered surfaces 4c3 and 4c4 disposed orthogonal to these tapered surfaces). In FIG. 1, since the movement of the operating body 1 in left and right directions is regulated (since the projection 3e and the concave portion 4c are quadrangular pyramidal in the embodiment, the movement of the operating body in the direction orthogonal to the sheet surface is also regulated), the operating body 1 is positioned without chattering in a direction orthogonal to the operating direction. Each projection strip 3d of the slider 3 is located inside the guide groove 4a of the casing 4. A clearance exists between the lateral surface of the slider 3 and the inner lateral surface of the casing 4, and between the projection strip 3d and the guide groove 4a.

When the operating body 1 is pressed in the state of FIG. 1, the operating body is pressed without being caught by the virtue of the existence of the clearance. Thus, as shown in FIG. 4, the driving portion 3f of the slider 3 gradually presses the tab 6a of the switch portion 6, then the movable contact contacts the fixed contacts, and then the switch is turned ON.

Next, if the operating body 1 is released from pressing in the state of ON shown in FIG. 4, the slider 3 (the operating body 1) is urged upward via the driving portion 3f by the tab 6a of the switch portion 6. At this time, the switch portion 6 pushes up the driving portion 3f in the vicinity of the left end of the slider 3, and a clearance exists as described above. Thus, the slider 3 is pushed up while being inclined to the right as shown in FIG. 5. Accordingly, a leading end 3ec of the left projection 3 of the slider 3 is shifted from a bottom center 4cc of the concave portion 4c to the right, the right tapered surface 3e2 of the projection 3e abuts on the right tapered surface 4c2 of the concave portion 4c (a process to a circled number 1 shown in FIG. 6). Then, while both the projections slide on the tapered surfaces, the slider 3 moves in the left direction (a process to a circled number 2 shown in FIG. 6), and then the slider 3 inclined to the right moves to be straightened (the state in FIG. 1).

Hereinafter, the above operation will now be described in detail.

In the present embodiment, the distances between adjacent projections 3e (between the right and left projections or between the upper and lower projections in FIG. 2) are set to be approximately equal to the distances between the concave portions 4c which face the adjacent projections.

Therefore, in a case in which the center of the projection 3e is shifted from the center of the concave portion 4c as shown in FIG. 6, when the tapered surface 3e2 of the left projection 3e contacts the tapered surface 4c2 of the left concave portion 4c, the tapered surface 3e2 of the right projection 3e parallel to the above tapered surfaces abuts on the tapered surface 4c2 of the right concave portion 4c. In this state, a space is defined which enables both the projections 3e to move in the left direction (in the direction indicated by a circled number 2). Therefore, the slider can move smoothly in the left direction, which reduces an abnormal noise.

Next, the reason why the operating body is constructed as such will be described in detail with reference to FIG. 7. In FIG. 7, a solid line indicates a case in which the distance between the adjacent projections equal to that between the concave portions. A two-dotted line indicates a case in which the interval between the adjacent projections is excessively smaller than the amount X of deviation from the center (in FIG. 7, a case in which Y is over zero). A broken line indicates a case in which the interval between the adjacent projections is excessively larger than the amount X of deviation from the center (in FIG. 7, a case in which that Z is over zero). In the case in which the interval between the adjacent projections is excessively smaller than the amount X of deviation from the center, the right tapered surface 3e2 of the left projection 3e and a left tapered surface 3e1a of the right projection 3e abut on the tapered surfaces of the concave portion. If there happens like this, the slider 3 hardly continues to move, and thus the slider 3 stops once. Therefore, a loud noise is likely to be generated. In addition, if the interval between the adjacent projections is excessively larger than the amount X of deviation from the center, the tapered surface 3e1b of the left projection 3e and the tapered surface 3e2 of the right projection 3e respectively abut on the tapered surface 4c1 of the left concave portion 4c and the tapered surface 4c2 of the right concave portion 4c, which causes the same problem.

In the present embodiment, in order to prevent the possibility that such a case occurs, the parallel tapered surfaces of the adjacent projections respectively abut on the corresponding parallel surfaces of the concave portions which face the projections. To describe in detail with reference to FIG. 6, since the slider 3 slides in a state where the tapered surface 3e2 is in contact with the tapered surface 4c2, even when the tapered surface 3e2 abuts on the tapered surface 4c2, they slide on each other without collision, by which an impact noise caused by bouncing is lessened. Further, since the slider 3 slides on the tapered surfaces 3e2 and 4c2 from the circled number 1 to the circled number 2, the ascending speed (moving speed) of the slider 3 can be decreased. Even in the state of FIG. 1, that is, when the tapered surface 3e1 and the tapered surface 4c1 abut on each other and are positioned, generation of an impact noise can be prevented. In addition, as the left and right tapered surfaces 3e1 and 3e2 of the right projection 3e also abut on the left and right tapered surfaces 4c1 and 4c2 of the right concave portion 4c, the partial force F1 is applied to position the projection 3e in the concave portion 4c, as shown in FIG. 3, and then the slider 3 returns to the non-operative state of FIG. 1.

Meanwhile, in the present embodiment, the tapered surface 4c2 of the left concave portion 4c or the tapered surface 3e2 of the left projection 3e is equivalent to a first tapered surface. Also, the tapered surface 3e2 of the right projection 3 parallel to the first tapered surface is equivalent to a second tapered surface. By the elastic force of the movable contact (the return member), the operating body 1 is guided and moved by the first and second tapered surfaces.

The tapered surface 3e1 of the projection 3e is equivalent to the operating body regulating portion, and the tapered surface 4c1 of the concave portion 4c is equivalent to the casing regulating portion. As the tapered surface 3e1 abuts on the tapered surface 4c1, the operating body 1 which has been guided and moved by the first and second tapered surfaces is regulated from moving upward (in a pressed and moved direction).

Although the above description has been made in conjunction with a case in which the operating body 1 is inclined to the right and shifted from the center. However, in a case in which the operating body 1 is inclined to the left and shifted from the center, and the tapered surface 3e2 abuts on the tapered surface 4c2 of the concave portion 4c after the tapered surface 3e1 of the projection 3e abuts on the tapered surface 4c1 of the concave portion 4c, since the operating body 1 is guided by the tapered surfaces 3e2 and 4c2, the tapered surfaces 3e1 and 4c1 are equivalent to the first and second tapered surfaces, respectively. Also, since the location of the operating body 1 is regulated by the tapered surfaces 3e2 and 4c2, the tapered surfaces 3e2 and 4c2 are equivalent to the regulating portions.

In addition, in a case in which the operating body 1 is shifted from the center in the vertical direction in FIG. 2, the tapered surfaces 3e3, 4c3, 3e4 and 4c4 are now equivalent to the first and second tapered surfaces, the operating body regulating portion, the casing regulating portion instead of the above-described tapered surfaces 3e1, 3e2, 4c1 and 4c2. The detailed description thereof will be omitted because this case is as same as the above description.

According to the present embodiment, since the operating body 1 slides in contact between the tapered surfaces 3e1 and 4c1 during the return of the operating body 1, an impact noise caused by bouncing is lessened. In addition, since the projection 3e abuts on the concave portion 4c (the casing regulating portion) to regulate the location of the operating body 1, the operating body 1 can be easily positioned.

Further, the knob 2 (an operating portion) protrudes from the middle of the operating body 1, and the tapered surfaces 3e1, 3e2, 3e3 and 3e4 are disposed to face each other with the knob 2 (the operating portion) interposed therebetween. By such construction, the tapered surfaces can be provided to be separated from each other. Thus, the tapered surfaces can stably slide on each other even with a small inclination of the operating body 1.

Since a positioning surface is provided continuously with the tapered surfaces 3e1, 3e2, 3e3 and 3e4, the structure for preventing the noise caused during the return of the operating body 1 and the structure for positioning the operating body 1 can be simplified.

Further, the tapered surfaces 3e1 and 3e2, the tapered surfaces 3e3 and 3e4, the tapered surfaces 4c1 and 4c2, and the tapered surfaces 4c3 and 4c4 respectively define a V-shaped tapered surface. After the slider abuts on one parallel tapered surface, it abuts on the other parallel tapered surface. In such a construction, a V-shaped section can be obtained when the concave portion is cut. Therefore, although the center of the projection is shifted from the center of the concave portion to some degree when the projection is fitted into the concave portion, noise can be prevented from being generated caused during the return of the slider, and the operating body 1 can be surely positioned.

In plan view, the tapered surfaces 3e1 and 3e2 and the tapered surfaces 3e3 and 3e4 respectively define a V-shaped tapered surface on a surface orthogonal to the above tapered surfaces in plan view. Therefore, although the center of the projection is shifted from the center of the concave portion to some degree when the projection is fitted into the concave portion, noise can be prevented from being generated during the return of the slider, and the operating body 1 can be surely positioned in any direction in plan view.

Further, since the projection 3e (and the concave portion 4c) is formed in the shape of a quadrangular pyramid on which tapered surfaces are provided, and the slider 3 is also quadrangular. Therefore, although the slider 3 is shifted from the center in any directions in plan view, the surface contact is made between the tapered surfaces. Thus, the contact between the tapered surfaces is smooth, which is very preferable for the operation.

In addition, although the projection 3e (and the concave portion 4c) is quadrangular pyramid-shaped in the embodiment, the present invention is not limited thereto, and a conical or triangular pyramid shape may be used.

As for the relation between the projection 3e and the concave portion 4c and the inclination (displacement) of the slider 3, when the slider 3 returns to its original position, the slider 3 ascends while being inclined by the return member at a position biased as much as clearance. At this time, it is preferable that the location of the leading end 3ec of the projection 3e of the slider 3 be inside the tapered surfaces of the concave portion 4c of the casing 4. It is also preferable that the leading end 3ec of the projection 3e be formed in the shape of a round surface rather than an angular surface.

Further, although the present embodiment has been described in conjunction with the construction in which the slider 3 is provided with the projection 3e and the casing 4 is provided with the concave portion 4c, the slider may be provided with a concave portion and the casing may be provided with a projection. Otherwise, the slider may be provided with either of a projection and a concave portion.

Further, in the present embodiment, both of the tapered surfaces of the projection 3e and the concave portion 4c are formed in the shape of a straight line, and while the surface contact is made between the tapered surfaces, the operating body is guided and regulated in position. However, since the tapered surfaces have only a guiding function, only one of the projection and the concave portion is enough to be the tapered surface. Also, since the regulating portion only determines a position, it need not be the face-to-face appearance.

Further, in the embodiment, as shown in FIG. 2, the quadrangular pyramid-shaped projections are provided at the four corners. As for the deviation in right and left directions in FIG. 2, a pair of projections 3e in the upper row and a pair of projections 3e in the lower row contribute to the prevention of noise and the positioning. As for the deviation in upward and downward directions in FIG. 2, a pair of projections 3e in the right column and a pair of projections 3e in the left column contribute to the prevention of noise and the positioning. Therefore, it is possible to stably achieve predetermined functions with a small number of the projections. However, a row of projections are provided in the middle in the left and right directions (between the upper and lower projections 3e in FIG. 2), a column of projections are provided in the middle in the vertical direction (between the left and right projections 3e in FIG. 2). Otherwise, projections can be provided only in the left and right directions, or only in the vertical direction.

Second Embodiment

FIG. 8 is a sectional view showing main parts of a push switch related to a second embodiment of the present invention.

In this embodiment, a tab 8 protrudes from the middle of the slider 3. With respect to the tab 8, a tapered surface 9a is provided one side of the slider, and another tapered surface 9b parallel to the tapered surface 9a is provided on the other side of the slider. These tapered surfaces 9a and 9b are inclined from the operating direction of the slider 3. Tapered surfaces 10a and 10b corresponding to the tapered surfaces 9a and 9b are provided in the casing 4. Also, flat surfaces 11 and 12 are provided.

By these tapered surfaces 9a, 9b, 10a and 10b, as the sliding occurs during the return of the slider 3 as described above, the moving speed of the slider 3 is decreased. As a result, generation of an impact noise is prevented. In the present embodiment, the tapered surfaces 9a and 10a are equivalent to the first tapered surfaces, the tapered surfaces 9b and 10b to the second tapered surfaces, the flat surface 11 to the casing regulating portion, and the flat surface 12 to the operating body regulating portion.

The construction of the second embodiment which is not described here is as same as the first embodiment.

In addition, while the movable contact of the switch portion 6 is equivalent to the return member, the present invention is not limited thereto. The slider can be returned by the means of an elastic member such as a spring or rubber other than the movable contact.

1. A push switch comprising:
an operating body having an operating body regulating portion;
a casing having a guide portion for holding the operating body in a vertically movable manner, and a casing regulating portion for regulating movement of the operating body in a direction opposite to a pressed and moved direction of the operating body by abutting the operating body regulating portion;
a return member which gives an elastic force so as to make the operating body regulating portion abut on a casing regulating portion;
fixed and movable contact which are brought into contact with or separated from each other according to a pressing operation and a releasing operation of the operating body;
a first tapered surface in at least one of the operating body and the casing and inclined from an operating direction of the operating body and a second tapered surface parallel to the first tapered surface; and
a gap provided between the casing and the operating body for allowing the operating body to move,
wherein during the return of the operating body, the operating body abuts on and is guided by the first tapered surface and the second tapered surface, and then the operating body regulating portion abuts on the casing regulating portion to regulate a position of the operating body in an operating direction.

2. The push switch according to claim 1, wherein an operating portion protrudes from a middle of the operating body, and the first and second tapered surfaces face each other with the operating portion therebetween.

3. The push switch according to claim 1, wherein at least one of the operating body regulating portion and the casing regulating portion is provided continuously with the first and second tapered surfaces.

4. The push switch according to claim 3, the first tapered surface and the operating body regulating portion of the operating body or the casing regulating portion of the casing defines a V-shaped tapered surface, and the operating body and the casing abut on parallel tapered surfaces on one side, and then abut on parallel tapered surfaces on the other side.

5. The push switch according to claim 4, wherein in plan view, a V-shaped tapered surface is defined on a surface orthogonal to the V-shaped tapered surface to form a quadrangular pyramid surface.
